(19) United States
(12) Patent Application Publication
(10) Pub. No.: US 2012/0245062 A1
(43) Pub. Date: Sep. 27, 2012

(54) USE OF HIGH RATIO AQUEOUS ALKALI SILICATES FOR PROFILE MODIFICATION, WATER CONTROL AND STABILIZATION

(76) Inventor: Michael J. McDonald, Toronto (CA)

(21) Appl. No.: 13/424,680

(22) Filed: Mar. 20, 2012

Related U.S. Application Data
(60) Provisional application No. 61/454,670, filed on Mar. 21, 2011.

(51) Int. Cl. C09K 8/42; C04B 28/26; C04B 14/00

(52) U.S. Cl. 507/260; 507/269; 507/276; 507/274; 106/482; 106/629; 106/634

(57) ABSTRACT

Soluble silicates are commonly used to block and strengthen permeable zones in subterranean formations. These applications include conformance for oil field, grouting for the construction industry and water shut-off for mining. It was discovered that set times and set properties could be improved by using novel, high ratio alkali silicates. Ratio being defined as the mol ratio of SiO₂:Me₂O, where Me is an alkali metal and is most commonly sodium or potassium (i.e. Na₂O and K₂O).

### CROSS-REFERENCE TO RELATED APPLICATIONS

This application claims priority to U.S. Provisional Patent Application No. 61/454,670, filed on Mar. 21, 2011. That application is incorporated by reference herein.

### FIELD OF THE INVENTION

This invention relates to the control of water and gas flows and more particularly to high ratio aqueous alkali silicates used for controlling subterranean water and gas flows.

### BACKGROUND OF THE INVENTION

The term conformance will be used to describe the management and alteration of water and gas flows in a subterranean environment to optimize hydrocarbon production. The term “water shut-off” is often used interchangeably with conformance. Water shut-off represents a major subset of conformance and refers to such problems as water flow through fractures thief zones, high permeability streaks and water coning, or lack of integrity in cement. It is estimated that unwanted water production costs are in excess of 50 billion dollars worldwide.

It has been known since the 1920's that sodium silicate is an effective means for providing conformance. Recently, there has been greater interest in the use of sodium silicate-based technology. This resurgence is being driven by the environmentally friendly nature of sodium silicate as well as the potential for lower costs and long term durability.

The chemistry of sodium silicate for conformance has been well documented in the literature. P. H. Krumrine and S. D. Boyce, Profile Modification and Water Control with Silica Gel-Based Systems, SPE 13578 presented at the 1985 SPE International Symposium on Oilfield and Geothermal Chemistry, Phoenix, Ariz., Apr. 9-11, 1985 is a leading article on the subject. This paper outlines the two basic reactions for setting sodium silicate. First, sodium silicate can be polymerized or gelled by lowering the pH. Second, the sodium silicate can be reacted with a multivalent cation (e.g. Ca⁺², Mg⁺², Al⁺³, Fe⁺³, etc) whereby the sodium silicate is made to precipitate. The paper provides an extensive list of potential setting agents.

There are several reasons often cited for choosing sodium-based technology for conformance applications. These reasons include:
initial low viscosity
small molecular weight which promotes penetration
excellent thermal stability
excellent chemical stability
high strength on setting
flexible set times (instant to several days)
environmentally friendly
moderate to low cost

There are various reasons cited for not selecting silicate-based technology. These reasons include:
gels can show syneresis (prone to shrinking)
gel time can be difficult to control

Over the years, many processes have been proposed for improving silicate-based technology for plugging high permeability and/or water-producing zones. However, in some instances the concerns listed above have not been completely addressed. This is in part the result of the ratio choice for alkali silicates. Existing technology is based on standard, commercially available ratio product.

In the silicate industry, the term ratio typically refers to the weight ratio of SiO₂ to Me₂O (where Me is the alkali metal and is most commonly sodium or potassium). Among scientists, it is more common to refer to ratio as the molar ratio of SiO₂ to Me₂O. Coincidentally, the molecular weight of Na₂O (62) and SiO₂ (60) are close enough that the molar ratio and weight ratio can be used interchangeably. For other sources of alkali silicate, the weight ratio does not match the molar ratio. Reference will be made herein to specify whether the ratio refers to weight or molar ratio.

Table I below, which is derived from U.S. Pat. No. 5,624,651 to Bass, presents the composition and typical properties of commercial grades of liquid sodium silicate and potassium silicate.

TABLE I

| | | Molar | | | | |
|---|---|---|---|---|---|---|
| Alkali | Wt. Ratio | Ratio | SiO₂ | Na₂O | Density | Viscosity |
| Metal | SiO₂:M₂O | SiO₂:M₂O | (%) | (%) | (lb/gal) | (centipoise) |
| Sodium | 3.75 | 3.87 | 25.3 | 6.75 | 11.0 | 220 |
| | 3.25 | 3.36 | 29.9 | 9.22 | 11.8 | 830 |
| | 3.25 | 3.36 | 28.4 | 8.7 | 11.6 | 160 |
| | 3.22 | 3.33 | 27.7 | 8.6 | 11.5 | 100 |
| | 2.87 | 2.97 | 32.0 | 11.1 | 12.4 | 1,250 |
| | 2.58 | 2.67 | 32.1 | 12.5 | 12.6 | 780 |
| | 2.50 | 2.58 | 26.5 | 10.6 | 11.7 | 60 |
| | 2.40 | 2.48 | 33.2 | 13.85 | 13.0 | 2,100 |
| | 2.20 | 2.27 | 29.2 | 13.3 | 12.5 | — |
| | 2.00 | 2.07 | 29.4 | 14.7 | 12.8 | 400 |
| | 2.00 | 2.07 | 36.0 | 18.0 | 14.1 | 70,000 |
| | 1.90 | 1.96 | 28.5 | 15.0 | 12.7 | — |
| | 1.80 | 1.86 | 24.1 | 13.4 | 12.0 | 60 |
| | 1.60 | 1.65 | 31.5 | 19.7 | 14.0 | 7,000 |
| Potassium | 2.50 | 3.92 | 20.8 | 8.3 | 10.5 | 40 |
| | 2.20 | 3.45 | 19.9 | 9.05 | 10.5 | 7 |
| | 2.10 | 3.29 | 26.3 | 12.5 | 11.5 | 1,050 |

Ratio is a major parameter that determines the type of silicate species in solution. Silicate speciation refers to the size and shape of silicate molecules found in solution. The building block for these silicate species is the SiO₄ monomer. FIG. 1 shows a small sample of the various silicate species that can be found in a silicate solution (e.g., monomer, dimers, trimers, oligomers, chains, rings of silicate anions, etc.).

FIG. 2 shows the trend towards high molecular weight, more complex polysilicate anions with increasing ratio of SiO₂:Me₂O.

Because of differences in the size, shape and distribution of silicate species, there will be different rates of chemical reactions and varying degrees of interactions with the treated area. The larger polysilicate anions in aqueous high ratio alkali silicate require significantly less setting agents to induce the polymerization and/or precipitation reaction.

The ratio of SiO2:Me2O is not increased to the point where the alkali silicate could be considered a silica sol also often referred to as colloidal silica. Sols are stable dispersions of discrete amorphous silica particles in a liquid, usually water. Commercial products contain silica particles having a diameter of about 3-100 nm, specific surface areas of 50-270 m²/g and silica contents of 15-50 wt %. According to Kirk-Othmer Encycolpedia of Chemical Technology, Fourth Edition, Volume 21, ISBN 0-471-52690-8, Copyright 1997 by John Wiley & Sons, such silica sols contain small (<1 wt %) amounts of stabilizers, most commonly sodium ions. A silica gel is a three dimensional network of silica particles.

Sodium silicate is the preferred alkali silicate for conformance applications. Occasionally, the more expensive and less available potassium silicate is used if there is a risk of surface contamination. While the focus of the present description is on sodium silicate, this invention is applicable to other forms of alkali silicate.

The use of sodium silicate for conformance has been extensively studied. These studies generally describe the sodium silicate with regard to specific brand names of sodium silicate, a reference to commercially available sodium silicate or a specified range of commercially available products. In Table I above commercially available sodium silicates can be defined as mol ratio equal or less than 4.0 for SiO₂:Na₂O.

U.S. Pat. No. 1,421,706 to Mills describes a process of excluding water from oil and gas wells. The patent discloses the use of metal salts or acid to set sodium silicate. The patent does not specify a ratio but states the use of commercially available sodium silicate.

U.S. Pat. No. 3,658,131 to Biles describes a technique for setting sodium silicate with calcium chloride brine. Ratio is not specified but the patent sites the use of a commercial grade of sodium silicate.

U.S. Pat. No. 4,031,958 to Sandiford et al. discloses the plugging of water-producing zones in a subterranean formation describes the use of polymers with sodium silicate. Sodium silicate is the preferred alkali metal silicate. Sandiford et al. discloses that any sodium silicate having a ratio of silica to sodium oxide of from about 1.5:1 to about 4:1 by weight may be used. Preferably the ratio should be from about 3:1 to about 3.5:1.

U.S. Pat. No. 4,257,813 to Lawrence et al. describes how sodium silicate gelation times and strengths may be controlled by adjusting the ratio of silicate to lignosulphonate. Useful water-soluble silicates are described as having mole ratios of 2.06 and 3.33 SiO₂/Na₂O and commercially available. Examples of other useful water-soluble alkali silicates are the potassium, lithium and quaternary ammonium silicates.

U.S. Pat. No. 6,059,036 to Chatterji et al. discloses methods and compositions for sealing subterranean zones by preparing a sealing composition comprised of an aqueous alkali metal silicate solution and a gelling agent selected from the group consisting of polyacrylate and polymethylacrylate. The chosen sodium silicate is a 3.2 ratio, Grade 40® sodium silicate solution.

U.S. Pat. No. 7,740,068 to Ballard discloses a method for treating a subterranean formation penetrated by a wellbore that includes injecting an alkali silicate into the wellbore and injecting a solid micronized silicate-precipitating agent into the wellbore. The ratio of silicon dioxide to alkali oxide may range from 1.6 to 3.3.

The idea of using CO₂ to set standard ratio sodium silicate was proposed in U.S. Pat. No. 2,402,588 to Andresen. There has been ureater interest in using sodium silicate to control the flow and placement of CO₂ for use in enhanced oil recovery. U.S. Pat. No. 5,351,751 to Chou et al. describes a method for silica gel emplacing a silicate gel to improve the sweep efficiency of water, gas, or steam flood operation by reducing the permeability of high-permeability thief zones. Controlled quantities of a silicate solution and either a gas or a gas and an organic acid are injected into a well to infiltrate and generate a controlled amount of a silicate gel. Chou et al. describes the use of PQ grade sodium silicate having a having a SiO₂:Na₂O weight ratio of 3.22.

To offset the shortcomings of sodium silicate, systems have been developed based on colloidal silica. U.S. Pat. No. 4,732,213 to Bennett et al. discloses the use of colloidal silica sol having a particle size in the range between 4 nm and 100 nm with a pH in the range between 1 and 10. The colloidal silica system described n Bennett et al. provides longer and more controllable set times than sodium silicate. However, the colloidal silica system requires a higher concentration of SiO₂ for setting, provides less strength and poorer injectivity, and is more costly, among other disadvantages. The polysilicate anions in aqueous high ratio alkali silicates are single-phase soluble chemistries, not solid separate phases of silica dispersed in water. Similar to standard ratio alkali silicates, the high ratio aqueous alkali silicates set by polymerization and/or precipitation reaction.

### SUMMARY OF THE INVENTION

Soluble silicates are commonly used to block and strengthen permeable zones in subterranean formations. These applications include conformance for oil field, grouting for the construction industry and water shut-off for mining. It was discovered that set times and set properties could be improved by using high ratio aqueous alkali silicates. Ratio being defined as the molar ratio of SiO₂:Me₂O, where Me is an alkali metal and is most commonly sodium or potassium (i.e. Na₂O and K₂O). For high ratio aqueous alkali silicates, the molar ratio of SiO2:Me2O can range from just over 4.0 to about 12.0. Most preferably from just over 4.0 to about 7.0. The pH of the aqueous alkali silicate is maintained above 10.

The conformance agent for managing water and gas flows of the present invention preferably includes a high ratio alkali silicate wherein the molar ratio of silica oxide to alkali oxide is greater than 4.0. In a preferred embodiment, the molar ratio of silica oxide to alkali oxide is greater than 4.5. This same agent can also serve as a water shut off agent for mining applications and a grouting agent for the construction industry.

### BRIEF DESCRIPTION OF THE FIGURES

FIG. 1 is a schematic representation of various silicate species that can be found in a silicate solution.

FIG. 2 is a graph showing the trend towards high molecular weight, more complex polysilicate anions with increasing ratio of SiO₂:Me₂O.

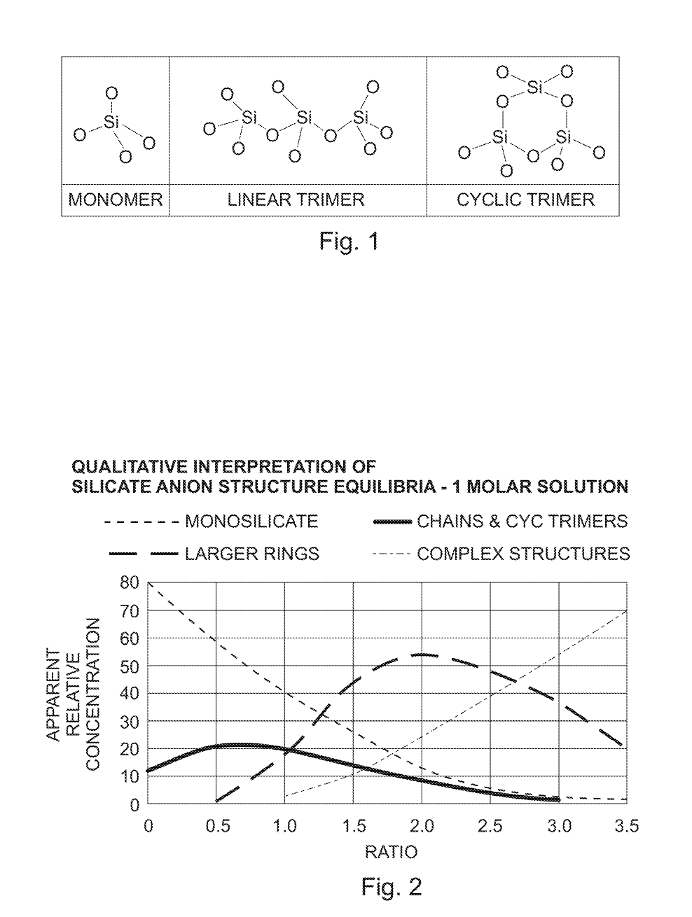

### DETAILED DESCRIPTION OF THE PREFERRED EMBODIMENTS

It has been discovered that high ratio aqueous sodium and potassium silicate can offer improved gelation times and set properties vs. traditional, commercially available SiO₂:Me₂O products. Further, these high ratio products can be particularly useful for subterranean applications to modify profile, control water and stabilization.

Two commercial processes exist for the production of sodium and potassium silicate. The more common of these two methods is the fusing of high purity sand with either soda ash or potassium carbonate in a furnace. The ratio of SiO₂ to Na₂O (or K₂O) is dependent on the quantity of raw material. This process can be represented by the following equation:

Na₂O+SiO₂————(SiO₂)ₓ.(Na₂O)+CO₂ x=1.8 to 3.22 (sodium silicate)

The second, commercial method of production is made without a furnace and involves the direct attack of silica with caustic. This method only allows for the production of lower ratio silicates. This method is represented by the following equation:

NaOH+SiO₂————(SiO₂)ₓ.(Na₂O)+CO₂ x=1.8 to 2.5 (sodium silicate)

The physical properties of alkali metal silicates such as viscosity, concentration and pH are controlled by the ratio of SiO₂ to Na₂O (and K₂O).

Prior art provides several different patents for the manufacture of high ratio alkali silicates beyond what is achievable using traditional manufacturing processes Typically, these high ratio silicates were developed for use in coatings and/or binder applications. U.S. Pat. No. 3,492,137 to Iler describes a stable, aqueous sodium polysilicate containing 10% to 30% by weight solids with a weight ratio of SiO₂ to Na₂O from 4.2:1 to 6:1. The high ratio aqueous silicate is prepared by mixing amorphous silica with a sodium silicate solution and heating the mixture between 40° C. and 100° C.

U.S. Pat. No. 3,625,722 to Von Freehold describes a process for preparing stable, alkali metal silicate solutions with a silica content from 10 to 35% and molar ratio ranging between 4:1 and 12:1. Soluble sources of silica are added to the silicate under heat. Stability is obtained by incorporating sufficient amounts of certain quaternary ammonium compounds.

U.S. Pat. No. 5,624,651 to Bass describes the a method of increasing the ratio of SiO₂:Me₂O using a cation exchange resin to remove smaller size anions from solution and leaving the larger more siliceous anions in the external solution. This method claims SiO₂:Me₂O molar ratios from about 3.5 to about 6.0

High ratio, aqueous sodium and potassium silicates can be prepared using methods described in the above patents. Using methods similar to those described in Iler, high ratio aqueous potassium silicates and aqueous sodium silicate were prepared with properties indicated in Table II. High ratio aqueous silicates were compared against PQ sodium silicate grade N® sodium silicate. N® sodium silicate has a weight ratio of 3.2 and represents the highest ratio for standard sodium silicate.

TABLE II
3.2 ratio sodium silicate vs. 4.5 ratio

| | N ® sodium silicate | High Ratio |
|---|---|---|
| Na₂O: | 8.9% | 4.7% |
| SiO2: | 28.7% | 21.1% |
| SiO2:Na₂O (weight) | 3.2 | 4.5 |
| Solids | 37.6% | 25.1% |
| Density | 1.38 | 1.24 |

### EXAMPLE 1

The gel times for internally catalyzed silicate systems can be difficult to control. Minor variation in catalyst concentration or reaction conditions may have a large impact on set times. More robust gel times would be considered a major technical advance and would allow for greater application. This example shows that the 4.5 ratio sodium silicate requires considerable less catalyst and can tolerate ureater changes in catalyst concentration.

Sodium Acid Pyrophosphate (SAPP) is a commonly used catalyst for mixing into sodium silicate prior to downhole placement. SAPP concentration was adjusted to give a set time of 4-6 hour set time. This represents the typical time need to mix and place the catalyzed sodium silicate downhole.

Gel time was monitored by taking viscosity readings using Brookfield PVS Rheometer PVS. Viscosity readings were taken at taken at 15 minute intervals at a shear rate of 5.11 s⁻¹. Temperature was 40.0° C. Viscosity builds were very rapid and the point of greatest increase in viscosity was considered the gel time.

The results of the set time between N® sodium silicate and SAPP are presented in Table III below.

TABLE III
Set time N ® sodium silicate vs. SAPP

| | | | |
|---|---|---|---|
| .90 x SAPP | Control | 1.1 x SAPP | 1.20x SAPP |
| control | SAPP | Control | control |

Mix 1 & 2

| | | | | |
|---|---|---|---|---|
| 1. water | 90 ml | 90 ml | 90 ml | 90 ml |
| 2. SAPP | 5.18 g | 5.75 g | 6.33 g | 6.90 g |

Mix 3 & 4

| | | | | |
|---|---|---|---|---|
| 3. N ® silicate | 37.5 ml | 37.5 ml | 37.5 ml | 37.5 ml |
| 4. water | 22.5 ml | 22.5 ml | 22.5 ml | 22.5 ml |

Add 1 & 2 to 3 & 4 and mix

| | | | | |
|---|---|---|---|---|
| Gel time | >10 hrs | 5 hrs | 90 minutes | 45 minutes |

The results of the set time between 4.5 ratio sodium silicate and SAPP are presented in Table III below.

TABLE IV
4.5 ratio vs. SAPP

| | | | |
|---|---|---|---|
| .90 x | Control | 1.1 x SAPP | 1.20x SAPP |

Mix 1&2

| | | | | |
|---|---|---|---|---|
| 1. water | 90 ml | 90 ml | 90 ml | 90 ml |
| 2. SAPP | 2.48 g | 2.75 g | 3.03 g | 3.30 g |
| 3. 4.5 ratio | 60 ml | 60 ml | 60 ml | 60 ml |

Add 1&2 to 3 and mix

| | | | | |
|---|---|---|---|---|
| gel time | 8 hrs, 45 min | 4 hrs, 45 min | 3 hrs | 2 hrs |

### EXAMPLE 2

Example 2 provides another example of how high ratio aqueous alkali silicates have more controllable gelation times and require lower concentrations of catalyst.

Citric acid represents another type of setting agent that can be mixed into sodium silicate and provide a delayed set time. Citric acid was mixed into water and then slowly metered into a silicate solution under agitation. The quantity of water was selected to give a final SiO₂ content of 9.6% by weight (i.e. 1 part N® grade sodium silicate to 2 parts water). Citric acid was added by weight as a weight percentage of SiO₂.

Gel time was monitored by taking viscosity readings using Brookfield PVS Rheometer PVS. Viscosity readings were taken at 15 minute intervals at a shear rate of 5.11 s⁻¹. To simulate near surface temperatures, samples were held at 15.0° C. Viscosity builds were very rapid and the point of greatest increase in viscosity was considered the gel time.

The results of the set time between N® silicate and 4.5 SAPP are presented in Tables V and VI.

TABLE V
Citric Acid Concentration vs. Set times for 3.2 ratio sodium silicate

| | 20% citric acid | 22.5% citric acid | 25% citric acid |
|---|---|---|---|
| | on 9.6% SiO₂ | on 9.6% SiO₂ | on 9.6% SiO₂ |
| Set time | 9 hours | 60 minutes | 30 minutes |

TABLE VI
Citric Acid Concentration vs. Set time for 4.5 ratio sodium silicate

| | 10% citric acid | 12.5% citric acid | 15% citric acid |
|---|---|---|---|
| | on 9.6% SiO₂ | on 9.6% SiO₂ | on 9.6% SiO₂ |
| Set time | 13 hours | 4 hrs 30 minutes | 45 minutes |

### EXAMPLE 3

Sodium silicate based gels can exhibit syneresis and therefore shrinkage. Reduction in syneresis would be considered a technical advance and should allow for greater use of sodium silicate in conformance applications.

Silicate gels were made using the same formulations used in Example 1. The gels were made in 250 ml clear, glass jars. The jars were sealed and stored at 40° C. At one week intervals, the amount of free water was decanted from the jar and weighed.

Over a 4 week period, the 4.5 ratio sodium silicate gels expelled significantly less water indicating less syneresis.

Table VII shows the water loss for N® sodium silicate using a SAPP catalyst.

TABLE VII
Formula and water loss for N ® sodium silicate using SAPP catalyst

| | .90 x | Control | 1.1 x SAPP | 1.20x SAPP |
|---|---|---|---|---|
| Water | 90 ml | 90 ml | 90 ml | 90 ml |
| SAPP | 5.18 | 5.75 | 6.33 | 6.90 |
| N ® sodium | 37.5 ml | 37.5 ml | 37.5 ml | 37.5 ml |
| silicate | | | | |
| Water | 22.5 ml | 22.5 ml | 22.5 ml | 22.5 ml |

Weight of water decanted

| | | | | |
|---|---|---|---|---|
| Week 1 | 42.69 g | 5.93 g | 5.88 g | 5.37 g |
| Week 2 | | 1.08 | 1.4 | .1 |
| Week 3 | | .08 | .13 | .15 |
| Week 4 | | .16 | .13 | .18 |

Table VIII below shows the water loss for 4.5 ratio silicate using a SAPP catalyst.

TABLE VIII
Formula and water loss for 4.5 ratio silicate using SAPP catalyst

| | .90 x | control | 1.1 x SAPP | 1.20x SAPP |
|---|---|---|---|---|
| water | 90 ml | 90 ml | 90 | 90 ml |
| SAPP | 2.48 | 2.75 | 3.03 | 3.30 |
| 4.5 | 60 ml | 60 ml | 60 ml | 60 ml |

Weight of water decanted

| | | | | |
|---|---|---|---|---|
| Week 1 | 1.21 g | 1.52 g | 1.72 g | 1.88 g |
| Week 2 | .91 | .43 | .28 | .1 |
| Week 3 | .25 | .33 | .28 | .22 |
| Week 4 | .17 | .24 | .22 | .13 |

Although the present invention has been described in connection with the petroleum industry, people familiar with the art will realize these high ratio silicates are readily adaptable to industries such as mining and construction.

High ratio aqueous alkali silicates would also benefit other oilfield applications such as oilwell cement, enhanced oil recovery as well as fracture fluids.

Although the invention is illustrated and described herein with reference to specific embodiments, the invention is not intended to be limited to the details shown. Rather, various modifications may be made in the details within the scope and range of equivalents of the claims and without departing from the invention.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Use of the term “about” should be construed as providing support for embodiments directed to the exact listed amount. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A conformance agent for use in managing water and gas flows comprising a high ratio aqueous alkali silicate wherein the molar ratio of silica oxide to alkali oxide is greater than 4.0 and less than 12.0

2. The conformance agent of claim 1 wherein the molar ratio of silica oxide to alkali oxide is greater than 4.5.

3. The conformance agent of claim 1 wherein the alkali oxide is sodium oxide.

4. The conformance agent of claim 1 wherein the silica oxide is potassium oxide.

5. The conformance agent of claim 1 further comprising a setting agent.

6. The conformance agent of claim 5 wherein the setting agent is one of sodium acid pyrophosphate and citric acid.

7. A water shut off agent comprising a high ratio alkali silicate wherein the molar ratio of silica oxide to alkali oxide is greater than 4.0.

8. The water shut off agent of claim 7 wherein the molar ratio of silica oxide to alkali oxide is greater than 4.5.

9. The water shut off agent of claim 7 wherein the alkali oxide is sodium oxide.

10. The water shut off agent of claim 7 wherein the silica oxide is potassium oxide.

11. The water shut off agent of claim 7 further comprising a setting agent.

12. The water shut off agent of claim 11 wherein the setting agent is one of sodium acid pyrophosphate and citric acid.

13. A grouting agent comprising a high ratio alkali silicate wherein the molar ratio of silica oxide to alkali oxide is greater than 4.0.

14. The grouting agent of claim 13 wherein the molar ratio of silica oxide to alkali oxide is greater than 4.5.

15. The grouting agent of claim 13 wherein the alkali oxide is sodium oxide.

16. The grouting agent of claim 13 wherein the silica oxide is potassium oxide.

17. The grouting agent of claim 13 further comprising a setting agent.

18. The grouting agent of claim 17 wherein the setting agent is one of sodium acid pyrophosphate and citric acid.
